(19) United States
(12) Patent Application Publication
(10) Pub. No.: US 2026/0162029 A1
(43) Pub. Date: Jun. 11, 2026

(54) COMPOSITIONAL MODELING SYSTEMS AND METHODS FOR GENERATING DELIVERABLES

(71) Applicant: State Farm Mutual Automobile Insurance Company, Bloomington, IL (US)

(72) Inventor: Nathan Shepherd, Le Roy, IL (US)

(21) Appl. No.: 19/407,974

(22) Filed: Dec. 3, 2025

Related U.S. Application Data
(60) Provisional application No. 63/729,060, filed on Dec. 6, 2024.

(51) Int. Cl. G06Q 10/0631; G06Q 10/067

(52) U.S. Cl. CPC G06Q 10/06311; G06Q 10/067

(57) ABSTRACT

A computer system is provided that uses compositional modeling to generate deliverables. The system may include one or more data sources storing historical action outcome data, historical resource data, and current resource data associated with an enterprise, and a compositional intelligence computing device configured to: (i) train a compositional model using the historical action outcome and resource data; (ii) receive a query identifying a deliverable; (iii) input a prompt to the compositional model; (iv) execute the compositional model using the prompt and the current resource data to generate output including the deliverable; (v) provide the deliverable; (vi) receive feedback related to the deliverable; (vii) re-execute the compositional model using the feedback to generate output including a revised deliverable; and/or (viii) control a resource scheduling component to implement one or more actions related to the deliverable.

### CROSS-REFERENCE TO RELATED APPLICATIONS

This application claims the benefit of priority to U.S. Provisional Patent Application No. 63/729,060, filed Dec. 6, 2024, the entire contents of which are incorporated by reference herein.

### FIELD OF THE DISCLOSURE

The field of the disclosure relates generally to using compositional modeling to generate deliverables, and more specifically, to a computing system configured to apply compositional modeling including executing a large language model (LLM) with foundational fine-tuning and retrieval augmented generation (RAG) techniques to generate deliverables including work sizing estimates, schedules, and other outputs for estimating, planning, scheduling, and/or otherwise implementing an enterprise-wide project.

### BACKGROUND

Today, one of the hardest problems for large enterprises is to determine the size and specific scope of enterprise-wide projects. Certain systems may divide larger projects into smaller deliverable for tracking and management. These enterprise projects are estimated, in some cases, by existing product teams with their “best guesses” with respect to size, complexity, and potential delivery estimates, based on various factors, including historical data and anecdotal evidence. However, this estimation is extremely difficult. In some cases, estimates are also not comprehensive, resulting in missing data. The outcome can include misinformed decision-making, with respect to starting work, stopping work, staffing projects, scheduling tasks and staff, allocating human- and computing-based resources, predicting task-based or overall deliverables, etc., which in turn result in project delay. Conventional techniques may include additional inefficiencies, encumbrances, ineffectiveness, and/or other drawbacks as well.

### BRIEF DESCRIPTION

The present embodiments may relate to, inter alia, compositional modeling systems and methods for generating deliverables (e.g., right-sizing estimates, resource scheduling). These systems and methods involve training and executing a compositional model, such as a large language trained generative AI model or large language model (LLM) with foundational fine-tuning and retrieval augmented generation (RAG) techniques. The use of the generative AI compositional model (and/or other AI and/or machine learning techniques) may be available in various mediums such as a computer and/or mobile application, chat screens, web page, voice interaction with a voice chat-capable connected home device, voice bots or chat bots, ChatGPT bots, and/or social media messaging. The system may include less, or alternate functionality, including that discussed elsewhere herein.

In one aspect, a computer system includes one or more data sources storing historical action outcome data, historical resource data, and current resource data associated with an enterprise, and a compositional intelligence computing device including at least one processor and at least one memory device, the at least one processor configured to: (i) train a compositional model using the historical action outcome data and the historical resource data; (ii) receive, from a user device, a query identifying a deliverable; (iii) input a prompt associated with the query to the compositional model; (iv) execute the compositional model using the prompt and the current resource data to generate output including the deliverable; (v) provide the deliverable to the user device; (vi) receive, from the user device, feedback related to the deliverable; (vii) re-execute the compositional model using the feedback to generate output including a revised deliverable; and/or (viii) control a resource scheduling component to implement one or more actions related to the deliverable. The computer system may include additional, less, or alternate functionality, including that discussed elsewhere herein. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another.

In another aspect, a method includes: (i) accessing one or more data sources to retrieve historical action outcome data, historical resource data, and current resource data associated with an enterprise; (ii) training a compositional model using the historical action outcome data and the historical resource data; (iii) receiving, from a user device, a query identifying a deliverable; (iv) inputting a prompt associated with the query to the compositional model; (v) executing the compositional model using the prompt and the current resource data to generate output including the deliverable; (vi) providing the deliverable to the user device; (vii) receiving, from the user device, feedback related to the deliverable; (viii) re-executing the compositional model using the feedback to generate output including a revised deliverable; and/or (ix) controlling a resource scheduling component to implement one or more actions related to the deliverable. The method may include additional, fewer, or alternative steps or actions, including those discussed elsewhere herein.

In a further aspect, one or more non-transitory computer-readable storage media having stored thereon computer-executable instructions may, when executed by at least one processor, cause the at least one processor to: (i) access one or more data sources to retrieve historical action outcome data, historical resource data, and current resource data associated with an enterprise; (ii) train a compositional model using the historical action outcome data and the historical resource data; (iii) receive, from a user device, a query identifying a deliverable; (iv) input a prompt associated with the query to the compositional model; (v) execute the compositional model using the prompt and the current resource data to generate output including the deliverable; (vi) provide the deliverable to the user device; (vii) receive, from the user device, feedback related to the deliverable; (viii) re-execute the compositional model using the feedback to generate output including a revised deliverable; and/or (ix) control a resource scheduling component to implement one or more actions related to the deliverable. The computer-executable instructions may cause a processor to perform additional, fewer, or alternative actions, including those disclose elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates an exemplary computer system for compositional modeling in accordance with the present disclosure.

FIG. 2 depicts a simplified flow diagram of compositional modeling in accordance with the present disclosure.

FIG. 3 depicts a simplified flow of foundational fine-tuning that may be used in the modeling flow of FIG. 2.

FIG. 4 depicts a simplified flow of retrieval augmented generation that may be used in in the modeling flow of FIG. 2.

FIG. 5 depicts a simplified schematic diagram of projects and elements thereof.

FIG. 6 depicts an exemplary configuration of a client computer device in accordance with one embodiment of the present disclosure.

FIG. 7 depicts an exemplary configuration of a server computing device in accordance with one embodiment of the present disclosure.

FIG. 8 depicts an exemplary configuration of a server computing system in accordance with one embodiment of the present disclosure.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, computer systems and computer-based methods that use compositional modeling to generate deliverables. In particular, in some embodiments, these computer systems and methods apply compositional modeling including executing a large language model (LLM) with foundational fine-tuning and retrieval augmented generation (RAG) techniques to generate deliverables including work sizing estimates, schedules, and other outputs for implementing an enterprise-wide project. In some instances, these systems and methods facilitate accurate and efficient sizing or estimation of large-scale projects using compositional modeling.

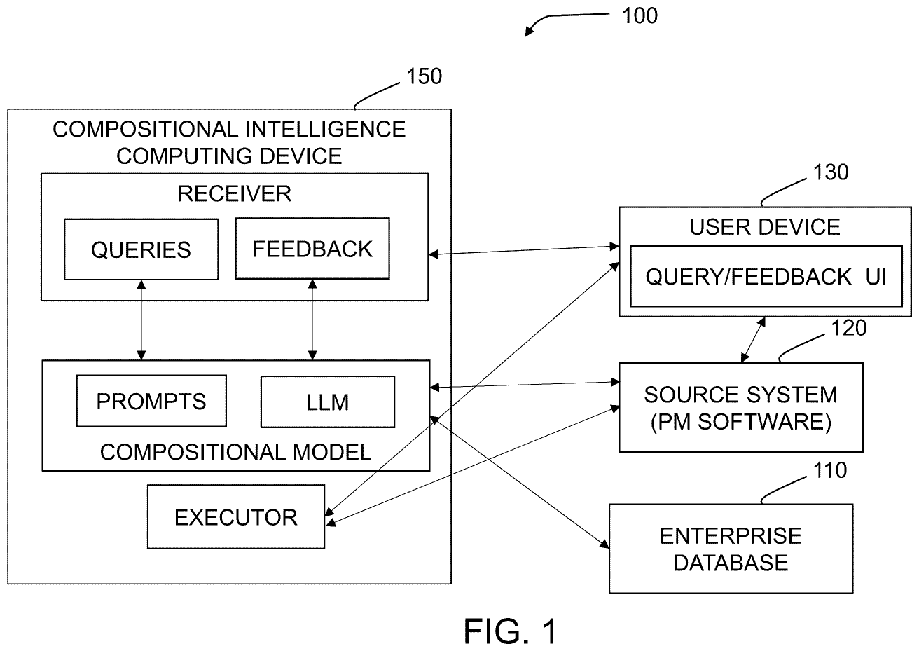

A computer system 100 may include a compositional intelligence computing device 150, an enterprise database 110, a source system 120, and a user device 130 in networked communication, as schematically depicted in FIG. 1. The compositional intelligence computing device is configured to ingest data (e.g., from the enterprise database, source system, and/or user device) to train and execute a compositional model, such as a large-language model (LLM). The compositional intelligence computing device uses a query or prompt as input to the compositional model and receives as output a deliverable. In some embodiments, the deliverable includes a sizing estimate for an enterprise project and/or a resource schedule for the enterprise workforce. The deliverable is provided to one or more users. Any feedback received from the one or more users is used as further input to the compositional model, which outputs a revised deliverable and embeds the feedback for re-training.

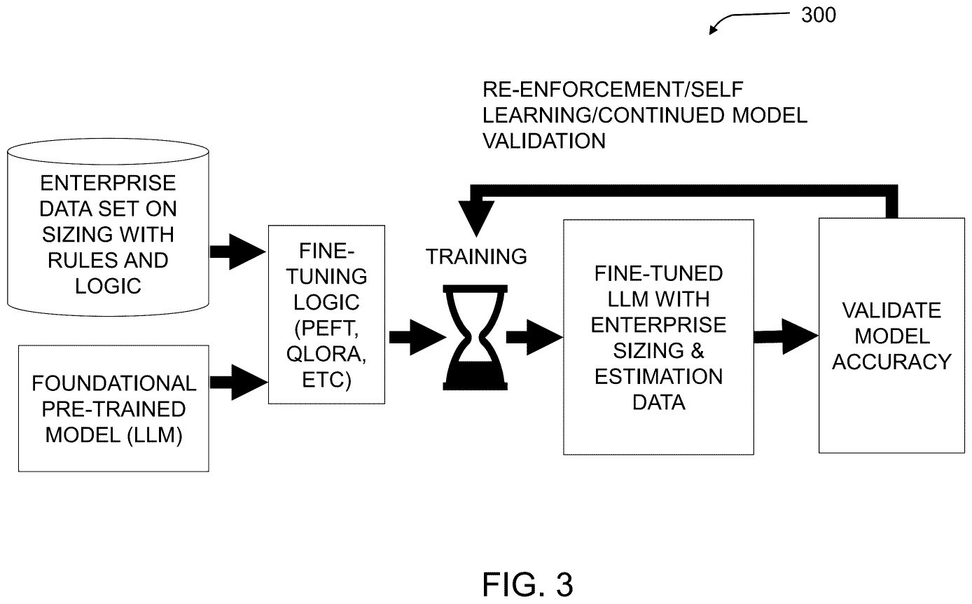

As shown in the schematic process 300 illustrated in FIG. 3, the compositional model, executed or implemented at least in part by the compositional intelligence computing device, is configured to receive an input such as a query or prompt, related to or including a request for a deliverable. The deliverable may include estimated right-sizing for a project and/or, in some cases, one or more specific elements of a project.

The compositional model is configured to ingest the contents of the prompt and apply inferences learned from historical data to generate an output, namely a deliverable, such as an estimate or other contextual response to the query. The output may be provided (e.g., displayed, transmitted, etc.) to one or more users for review. In one exemplary embodiment, the one or more users provide feedback related to the output, and the compositional intelligence computing device ingests the feedback, re-executes the compositional model, and provides, if appropriate, a revised output. Still further, the compositional model applies the feedback in a re-training process to further refine its modeling functionality. In addition, in the exemplary embodiment, the compositional intelligence computing device has access to ongoing action data, such as progress data related to a project once it is underway. This ongoing action data is fed into the compositional model for validation of the estimation(s) made thereby and for re-training of the modeling functionality.

In the context of the present disclosure, a query may refer generally to an input received from a user (e.g., via some user interface), whereas a prompt may refer generally to the input that is fed into the compositional model. For example, a user may input a query such as “how long will it take to implement Action X?” As described further herein, the computer system is configured to interpret, process, and modify the content of the query to generate and format a prompt, which, when executed, facilitates the compositional model generating and providing a data-rich, precise, contextual output (e.g., a deliverable such as an estimate, resource schedule, etc.).

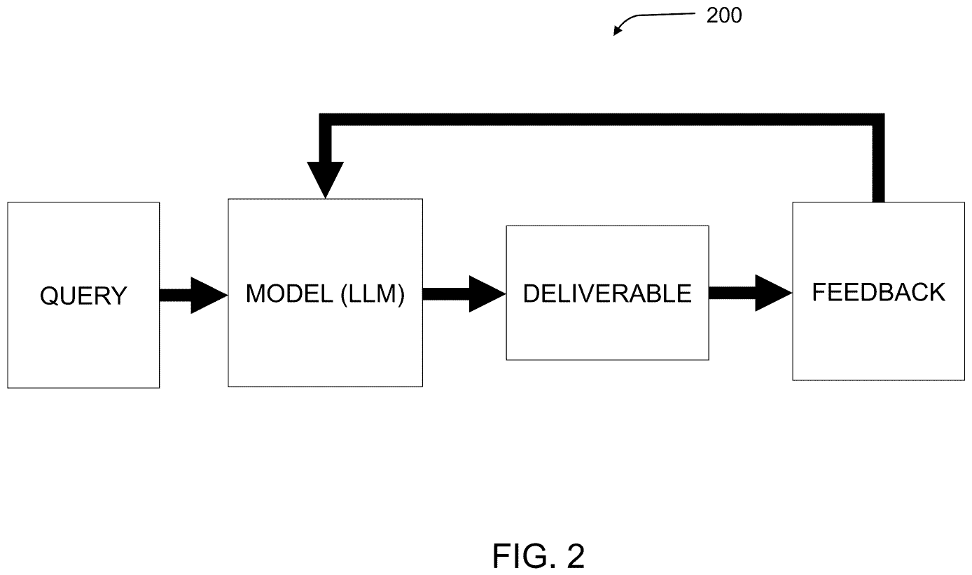

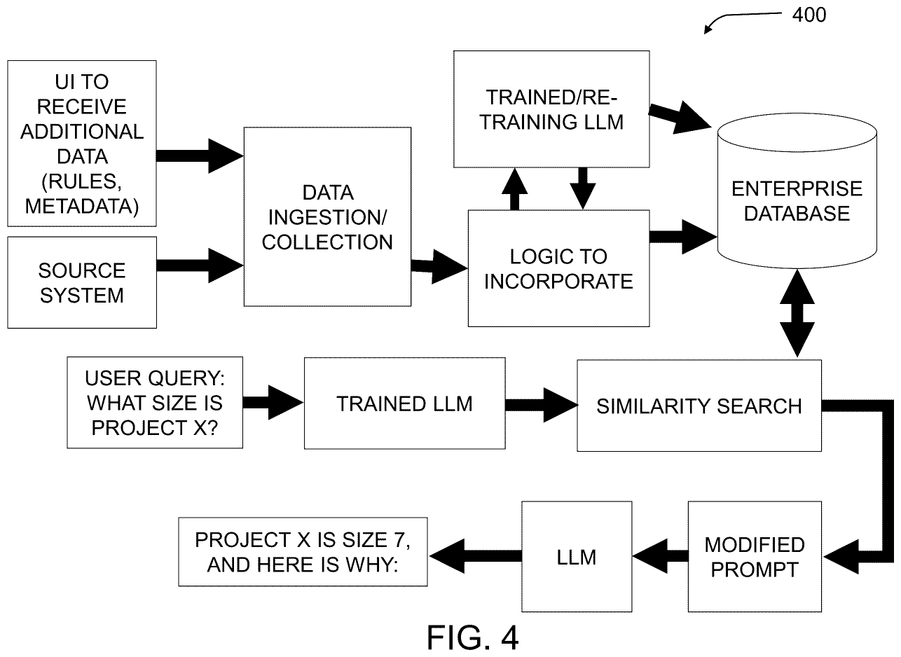

As described further herein, the compositional model may include a large-language model (LLM), as shown in FIGS. 1-4. The LLM may include, in some embodiments, a large language trained generative artificial intelligence (GAI) model (e.g., ChatGPT). In some embodiments, the compositional model may include one or more additional or alternative machine learning (ML)/GAI components, models, etc., which may supplement or enhance any of the compositional modeling described herein. In addition, compositional modeling may include multiple modeling strategies and schemas that, when combined, facilitate the generation of the deliverables described herein. In one exemplary embodiment, as depicted in FIG. 3, foundational fine-tuning techniques 300 are applied (e.g., using historical data) to initially train the compositional model (e.g., the LLM) and, as the model is executed, feedback is received, and/or ongoing action data is received, to re-train the compositional model. In one exemplary embodiment, as depicted in FIG. 4, retrieval augmented generation (RAG) techniques 400 are applied to solicit user inputs—which may include feedback related to a specific deliverable as well as more generalized or enterprise-level inputs—that are used to refine and/or validate the inferences and assumptions of the compositional model, and to generate contextual prompts.

The enterprise database, as shown in FIG. 1, is configured to store enterprise data. This enterprise data may include, for example, historical action outcome data, which includes data related to actions implemented in the context of the enterprise, such as projects undertaken within the enterprise over some preceding period of time. Historical action outcome data may be referred to herein as historical project data. Historical action outcome data may include any number of parameters and related values, where at least some of such parameters may be unique to the enterprise. At least some parameters (or fields) that may be included in historical action outcome data include—but are in no way limited to—action/project labels, feature labels, story labels, task labels, activity labels, resource/team/team member identifiers, time/date parameters, initial or expected action/project parameters (including final parameters and/or intermediate or ongoing parameters), actual action/project parameters (including final parameters and/or intermediate or ongoing parameters), location parameters, budget parameters, parameters related to elements added or removed during a project, a completion parameter (e.g., indicating whether an action/project was completed [yes/no] or a percentage completed [0-100%]), regulatory parameters, and/or additional or alternative parameters. Time/date parameters may include—but are in no way limited to—start and end dates related to an overall project and/or element(s) or part(s) thereof, including anticipated start/end dates as well as actual start end/dates. For each project, some or all of these available parameters have parameter values populated within the historical project data, stored in the enterprise database as historical action outcome data, for example.

The source system, also shown in FIG. 1, represents a scheduling/workforce/project management system associated with the same enterprise. The source system generates and stores historical and current data related to enterprise resources. This resource data may include historical and current parameters, such as, but in no way limited to, employees, team compositions, employee experience (e.g., in terms of duration and/or skills/competencies), workforce schedules, workforce assigned projects and/or project elements, workforce capacity, workforce location, and/or additional or alternative parameters. Some or all of these available parameters have parameter values populated within (and, in many cases, by) the source system. In some embodiments, the source system stores some or all of the above-described data within the enterprise database. In some embodiments, the source system locally stores current resource data and offloads historical resource data on a periodic basis for storage at the enterprise database (e.g., as part of or separate from the historical action outcome data). Therefore, in some embodiments, at least some of the historical action outcome data originates from the source system.

In addition, the source system includes or is otherwise communicatively coupled to a resource scheduler, which may include, for example, a calendar-based system that captures time on employee's schedules for assigned actions or projects. Time capture, in this context, may include both reading and writing functions, such as both reading schedules and identifying time that is available or unavailable (and/or time that may be unavailable but movable) as well as writing entries onto a schedule to thereby make the related time unavailable (with any level of flexibility).

The compositional intelligence computing device is in communication with the enterprise database and is configured to ingest the historical action outcome data. The compositional intelligence computing device is also in communication with the source system and is configured to ingest the resource data. There may be other data sources (both active, like the source system, or passive, like the enterprise database) within the computer system and/or otherwise accessible to the compositional intelligence computing device.

The compositional intelligence computing device is configured to train the compositional model using these data sets, where such training may include foundational fine-tuning techniques, as shown generally in FIG. 3. The compositional model processes historical action outcome and historical resource data to learn about actions undertaken at the enterprise and corresponding outcomes, such that the compositional model is configured to generate contextual deliverables related to anticipated actions. For example, the compositional model learns historical project sizing, such that the compositional model is configured to generate sizing estimates related to new projects.

In one embodiment, the compositional model is configured to discretize historical data sets into multiple hierarchical elements (e.g., features, stories, tasks, activities, as described further herein). The compositional model ingests the historical data sets that, in some instances, define or label individual elements, such that parameters are readily associated with the corresponding element(s). The compositional model may use the parameters and associated values to learn how associated data sets are broken down into smaller parts, and how those smaller parts were implemented and completed (or, in some instances, not completed). That is, the compositional model, in training, learns to recognize temporal and other contextual relationships between various parameters and/or between the elements to which the parameters may be related. The compositional model may then self-train to automatically discretize other historical data sets that do not include such element definition.

The compositional model may also self-identify parameters that were not previously defined within the data sets. That is, in training, the compositional model may recognize relationships/trends/patterns within the data that were not labeled or that had no available associated field. These relationships may be, for example, correlations between parameters that were previously unrecognized. In this way, the compositional model may recognize and define new parameters related to historical actions or events. The compositional model may also be trained on and/or self-identify various rules, which may enforce temporal restrictions between elements, or which may restrict which parameters can be correlated (e.g., based on various jurisdictional regulations).

The compositional intelligence computing device is configured to receive queries from users requesting deliverables. In the example embodiment, the compositional intelligence computing device includes a receiver, as shown in FIG. 1. The receiver may include a communication interface and requisite functionality to generate and cause display of a user interface through which the user(s) interact with the compositional intelligence computing device. In some instances, the compositional intelligence computing device includes display and input/output components with which the user(s) interact. Additionally or alternatively, the compositional intelligence computing device is communicatively coupled to a user device associated with the user (e.g., via an API communication channel) and causes display of a user interface at the user device, as shown in FIG. 1, through which the user can interact with the compositional intelligence computing device. In particular, the user may input queries into the user interface, which are transmitted to and received by the compositional intelligence computing device (e.g., the receiver).

A query may include any number of parameters or other details. For example, a query may be as simple as “How long will it take to complete Action X?” As another example, a query may be more specific, such as “how long will it take to complete Feature A of Action X with Resources 1 and 2?” Other data points may be requested by the user submitting the query, such as, in the context of projects, an estimated complexity or estimated budget related to a project or element(s) thereof.

In the example embodiment, the query is input to the compositional model or, in some instances, into an intermediate component executed by the compositional intelligence computing device (e.g., as a separate processing module), to modify the query into a contextual prompt for the compositional model to execute its sizing estimation functionality. The query may be expanded to include parameters related thereto, based on parameters related to similar or relevant historical data parameters. In this way, a user does not need to “know” all of the relevant details that would be needed to actually generate a contextual deliverable but can input a relatively simple query.

In some cases, the query modification may be performed in a way that is invisible to the querying user. That is, the querying user may not have direct purview into the ways the query is modified (if at all) to generate the contextual prompt. In other cases, the compositional intelligence computing device causes display of a demonstration interface that demonstrates, to the querying user, how their input query is modified to generate the contextual prompt. The demonstration interface may be implemented using words/alpha-numeric characters, graphical icons, “code-like” text, and the like. In some embodiments, the demonstration interface may be a single or minimal interface that depicts the final form of the contextual prompt in a user-interpretable format, such as single section of text.

The contextual prompt is then used as input to the (trained) compositional model to execute its learned functionality. The compositional model is configured to discretize input related to the prompt, identifying and defining a plurality of hierarchical elements that collectively compose a related data set. The compositional model is also configured to ingest current resource data, which may be retrieved from the source system at the time of the query or periodically stored in a local storage location associated with the compositional intelligence computing device. The compositional model is further configured to perform any other computations for generating the requested deliverable.

The compositional model is configured to generate the deliverable including various details related to the query, such as values, ranges, scores, dates, statements, thresholds, or any other usable format or, in some instances, requested format. The project sizing output may include various other data, such as, but in no way limited to: diagrams or schedules; timelines; resource identifiers; suggestions or recommendations that may influence other details; and/or assumptions, inferences, or computations used to generate any of the above details. In some embodiments, the output may be highly interactive, such as a widget that enables users to navigate a schedule or “zoom” in and out to view information at different levels of granularity. For example, a first output may include a broad prediction or recommendation, and, in response to a specific user input (e.g., a tap, a click, a “pinch” type motion, etc.), a second output may include a representation of the input query, a set of assumptions generated using the query and/or the resource data, and the resultant prediction or recommendation.

Any output may be stored or collected in a storage or retrieval location that is accessible to the compositional intelligence computing device and one or more user devices. The output may be requested, retrieved, formatted, or accessed in various formats or combinations. For example, the compositional model may provide output in some default format, such as a sentence or other text-based response to the user's query, and, upon request from the user, may generate a graphic visual representation of one or more other details for display to the user. In some embodiments, the compositional model may output data in a data interchange format (e.g., JavaScript Object Notation (JSON)), which may be interpreted by other components of the system to display information.

In some embodiments, this output may represent an initial or preliminary deliverable, which is subject to review by and feedback from one or more users (e.g., as part of a retrieval augmented generation modeling strategy). The users may provide additional parameters/parameter values for consideration, resource-specific rules or rule exceptions, adjustments or corrections to one or more assumptions made by the compositional model, and/or anticipated resource changes. The users may also provide location-specific feedback, which may include regulations, restrictions, legislative timelines, location-specific holiday or seasonal information, and the like. It should be recognized that any/all of the above data points may, in some embodiments, be accessible to and accounted for by the compositional model in initial training, depending on the robustness or availability of data from the various data sources. Additionally or alternatively, any/all of the above data points may, in some embodiments, be provided to the compositional model during a query phase.

In some embodiments, this presentation and feedback interaction is conducted within a user interface generated and displayed on a user device by the compositional intelligence computing device, or within an interface integral to the compositional intelligence computing device. In some embodiments, the output from the compositional model is transmitted to and/or accessible to the source system, and users interact with the output via an interface or dedicated dashboard related to the source system (e.g., within a project management software interface).

Where feedback is received or otherwise input into the compositional model, the compositional model applies the feedback to generate a revised deliverable. For example, the compositional model uses the feedback as additional data or parameters for execution of the modeling functionality with otherwise the same actions (e.g., input discretizing, resource analysis, etc.). The revised deliverable may be stored, displayed, and interacted with in the same ways as described above (including, where applicable, receiving additional feedback to iterate the above actions). The revised deliverable may include any/all of the details described above with respect to the preliminary deliverable. In some embodiments, the revised project sizing output may further include additional details, such as an identification of the new/revised information or instruction received during the feedback phase (and, in some case, the source of such new/revised information or instruction); any change in assumptions or inferences; and/or how any change in information or assumptions changed one or more other details between the preliminary deliverable and the revised deliverable.

In some embodiments, this feedback and revision is conducted in real-time. In some specific embodiments, output from the compositional model may be presented to user(s) within a highly interactive and dynamic interface. In such cases, a user may provide feedback within that interface, such as by de-selecting or modifying a displayed parameter value or assumption. The compositional model may execute the feedback and revision actions in real-time such that the interface is dynamically updated to reflect the revised output. This arrangement enables the user to readily see and understand how various changes to the model inputs affect related deliverable details, such as estimated timelines.

In some embodiments, the compositional model also uses the feedback for self-retraining of its modeling functionality. This may be automatic, or may be conducted in response to a command from a user, such as where the user actively indicates the revised output was more accurate, more favorable, or is otherwise more contextually preferred.

The compositional intelligence computing device is further configured to execute one or more actions (e.g., using an executor module, as shown in FIG. 1) in response to a deliverable being approved or finalized. The compositional intelligence computing device may instruct the source system to modify or assign various resources associated with the deliverable. In some embodiments, the compositional intelligence computing device is communicatively coupled to the source system, such as via an API communication channel, such that the compositional intelligence computing device receives or accesses a “real-time” or ongoing stream of data. The compositional intelligence computing device is further configured to monitor this data and to feed it back into the compositional model as feedback for validation or adjustment of the modeling functionality. Therefore, the model is continuously refined based on ongoing (and sometimes real-time) action data. In some cases, the compositional model may identify a new parameter or a new correlation that was previously unrecognized. The compositional model may self-train by applying this newly identified parameter to the historical action outcome data that is then fed back into the compositional model for validation or refutation of the newly identified parameter. Moreover, in certain embodiments, the compositional model applies the validation/feedback on a continuous or periodic basis to therefore generate revised deliverables on a continuous or periodic basis.

As described herein, the compositional modeling systems of the present disclosure may be implemented in the context of an enterprise project. As used herein, a project represents a comprehensive or over-arching endeavor, or a desired end point. Deliverables related thereto may include project sizing estimates and/or resource schedules. Sizing a project refers to a process of estimating how long a project will take to complete and what resources are required to accomplish the estimate. As used herein, the terms project sizing, sizing estimate(s), estimations, and other such terms for deliverables may be used interchangeably. In some instances, a deliverable may also include a score or rating, which may refer to an expected complexity of completing the project. In some instances, a deliverable may also include other details, such as a confidence level in the content of the deliverable (e.g., a confidence in the estimate of the duration of the project).

As one example, for illustration purposes, a project may include developing a new accounting system. It is readily recognized that a query for a related deliverable, such as “how long will it take to develop a new accounting system?” is an incredibly difficult question to answer, with innumerable, complex variables that may influence an estimate. Put simply, a human cannot reasonably respond to such a query, with any confidence or precision, without a level of research and computation that could not completed within any useful timeline.

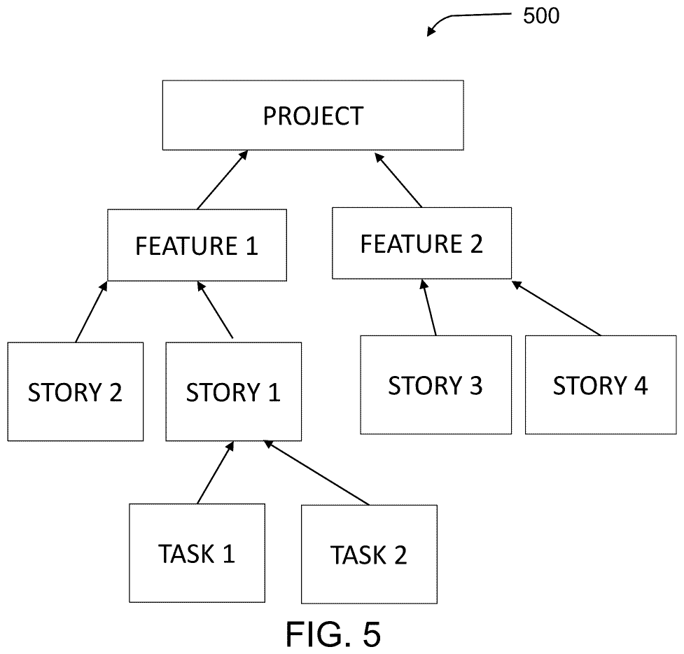

A project can be understood as a plurality of elements, as shown schematically in FIG. 5 as a project 500. As used herein, the terms “story,” “feature,” “task,” and activity” refer to the elements that collectively form a project to be completed. In the exemplary embodiment, a project is made up of features, which are in turn made up of stories, which are in turn made up of tasks, which are in turn made up of activities. In some embodiments, the relative “hierarchy” between elements may be different, or certain elements may not form a part of a project (e.g., one project may be made up of stories and, in turn, tasks; another project may be made up of features and, in turn, stories; another project may be made up of features and, in turn, tasks; etc.).

Continuing with the illustrative example above, the new accounting system (project) may include an accounts receivable feature and an account payable feature. Stated differently, the project may be broken down or reduced into these two features, or the project may be formed from or made up of these two features. For the purposes of clarity and simplicity in this illustrative example, one or more of these two features may be described further, but it is understood that various other features may make up any project and, indeed, many projects include more than two features.

The accounts receivable feature may, in turn, include a plurality of stories, such as an intake story, a processing or routing story, and a recording story. Stated differently, the feature may be broken down or reduced into these three stories, or the feature may be formed from or made up of these three stories. For the purposes of clarity and simplicity in this illustrative example, one or more of these three stories may be described further, but it is understood that various other stories may make up any feature and, indeed, many features include more than three stories.

The intake story may, in turn, include a plurality of tasks, such as a software development task, an isolated testing task, an integration task, an integrated testing task, and a roll-out task. Stated differently, the story may be broken down or reduced into these five tasks, or the story may be formed from or made up of these five tasks. For the purposes of clarity and simplicity in this illustrative example, one or more of these five tasks may be described further, but it is understood that various other tasks may make up any story and, indeed, many stories include more than five tasks.

While this illustrative example may appear simple, it should readily be recognized that in a more realistic implementation, each of these steps may result in many more “branches” or elements, which could result in tens, hundreds, or thousands of the smallest or most granular elements to be performed or completed (e.g., tasks or activities). In such cases, even the identification and definition of these granular elements may take significant time, research, and understanding of a project. This, in itself, may be an unreasonable undertaking for a human, if it can even be completed, let alone within any useful timeline.

Even further, each of these elements, from granular to broad, are associated with enterprise resources—that is, one or more person(s) and/or system(s) that implement, for example, an individual task or collective feature. Incorporating the consideration of teams and team members, with respect to each most-granular element as well as the interconnected nature of elements, even further complicates the assessment of a project. It would be impossible, in practice, for a human analyst to make and incorporate all such considerations into a project sizing estimate. This limitation exists even for projects that imitate previously completed project. If a project is an entirely new endeavor, the above considerations get even more complex.

The computer system of the present disclosure may overcome these limitations, at least in part by training, executing, and re-training a compositional model, as described herein.

At least some of the technical benefits provided by the disclosed system may include: incorporating human feedback on deliverables into further execution and/or training of compositional models, including in real-time or during on-going execution thereof, to enhance contextual data interpretation; ongoing training or fine-tuning of compositional models to improve outputs in real-time; using retrieval-augmented generation techniques to refine and/or validate inferences and assumptions of the compositional model, thereby improving outputs; improved labeling of uncategorized data and/or predicted data; enhanced model ability to self-identify parameters and parameter relationships within categorized, uncategorized, or predicted data; automatic generation of model prompts queries with improved context; generation of model outputs with improved interactive functionality that enable user investigation thereof at different hierarchical levels, including self-identification of assumptions, changes between sequential executions/trainings, etc.; model re-training responsive to user input indicating a changed output is preferable to a preliminary output; and/or enabling interpretation of vast data sets beyond the capability of a human mind to present deliverables.

In many instances, an enterprise may operate on data that is confidential or that otherwise requires significant security measures to protect, such as, for example, personally identifiable information (PII), trade secrets, proprietary data or algorithms, etc. It has been recognized that there is a significant technical improvement over existing distributed systems in providing the described functionality within a software or firmware package that may be implemented within an enterprise system. In this way, the enterprise may utilize all of the functionality of the disclosed system and achieve the disclosed technical benefits, without sacrificing data security. That is, the software- and/or firmware-based “sub-system” may perform the described actions on enterprise data without such data being transmitted to or accessed by any external entities.

It should be readily understood, however, that there exist myriad data security schema for data protection during data access/transmission between entities, and the technical improvements of the present system may be safely realized in a distributed system (e.g., between separate entities).

For illustration purposes, in the context of enterprise projects, historical project data and resource data may indicate, for a historical project, which project elements (features, stories, etc.) were defined, which teams/members of the workforce worked on those defined elements, how long each element took to complete, which lower-level elements fed into which higher-level elements, which teams or elements experienced delays or outperformed expectations, which elements were identified as more complex or more critical to project outcome, and the like. For example, the historical project data may be as granular as to indicate that Team Member 1 worked on and completed a JSON-based UI task within a specific duration. Such data can be readily leveraged when an anticipated project may involve the generation of a JSON-based UI.

In one embodiment, the compositional model is configured to discretize historical projects into multiple hierarchical elements (e.g., features, stories, tasks, activities, as described further herein). The compositional model ingests the historical project data that, in some instances, defines or labels project elements, such as features, stories, etc. that were pre-defined (e.g., before a project began) or post-defined (e.g., after the project was underway or completed) for a historical project. That is, the compositional model uses the parameters and associated values to learn how projects are broken down into smaller parts, and how those smaller parts were assigned, conducted, and completed (or, in some instances, not completed). That is, the compositional model, in training, learns to recognize temporal and contextual relationships between project elements and the associated workforce requirements or inputs. The compositional model may employ this learned project division and automatically discretize historical projects that do not include such element definition. In some instances, the compositional model may discretize a project into more granular elements that were previously defined within the historical project data.

In the context of project sizing estimates, a prompt is used as input to the (trained) compositional model to execute its sizing estimation functionality. The compositional model is configured to discretize an input project, identifying and defining a plurality of hierarchical project elements that collectively compose the project. The compositional model is also configured to ingest current workforce data, which may be retrieved from the source system at the time of the query or periodically stored in a local storage location associated with the compositional intelligence computing device. The compositional model is further configured to perform computations that estimate when and how the identified project elements (and, thereby, the overall project) can be completed by the associated current workforce.

The deliverable in such contexts may include a project sizing output, which includes an estimate of duration of the project and/or project element(s) related to the query. The project sizing output may include estimate(s) of project complexity, budget, etc., based on the initial query. Some of these estimates may be values, ranges, scores, dates, statements, thresholds, or any other usable format or, in some instances, requested format. The project sizing output may include various other data, such as, but in no way limited to: the identified project elements (features, stories, tasks, elements), which may be limited to a specified granularity; duration estimates for each or a subset of identified project elements; diagrams or schedules related to the project and/or project elements; timelines; identifiers of the workforce (team members) for the project and/or project elements; suggestions or recommendations that would positively influence any above estimates (e.g., this story may be completed one week faster if these two team members become available to work on it); and/or assumptions, inferences, or computations used to generate any of the above details.

In some embodiments, this output may represent an initial or preliminary estimate. As described herein, users may provide feedback such as, but not limited to, additional parameters/parameter values for consideration, team-specific rules or rule exceptions, adjustments or corrections to one or more assumptions made by the compositional model (e.g., the experience of the team is greater or less than indicated by the workforce data and relied upon; this UI should actually be generated in a different language or ecosystem; etc.), parameters/values that may have a known but irregular deviation (e.g., breaks for holidays, an upcoming leave not reflected in the workforce data, etc.), and/or anticipated team changes (e.g., anticipated hiring, team transitions, etc.).

Where feedback is received, the compositional model applies the feedback to generate a revised estimate. For example, the compositional model uses the feedback as additional data or parameters for execution of the modeling functionality with otherwise the same actions (e.g., project discretizing, workforce analysis, etc.). The compositional model is configured to generate a revised project sizing output, which may be stored, displayed, and interacted with in the same ways as described above (including, where applicable, receiving additional feedback to iterate the above actions). The revised project sizing output may include any/all of the details described above with respect to the preliminary project sizing output. In some embodiment, the revised project sizing output may further include additional details, such as an identification of the new/revised information or instruction received during the feedback phase (and, in some case, the source of such new/revised information or instruction); any change in assumptions of inferences; and/or how any change in information or assumptions changed one or more estimates between the preliminary project sizing output and the revised project sizing output (e.g., one feature has a longer estimated duration).

The compositional intelligence computing device is further configured to execute one or more actions when the project is initiated (e.g., using an executor module, as shown in FIG. 1). In some embodiments, the compositional intelligence computing device is configured to receive an indication when a generated project estimate is accepted. Additionally or alternatively, the compositional intelligence computing device receives or access a “real-time” or ongoing stream of workforce data, and the compositional intelligence computing device may detect project initiation based on the stream of workforce data.

When the project is initiated, the compositional intelligence computing device may designate the most recent estimate as the “final” estimate, and leverage the final estimate to engage the source system. The compositional intelligence computing device may instruct the source system to implement the final estimate within the scheduling functionality and to notify or instruct the associated team members about the initiated project and their role(s). In some embodiments, the source system, under instruction from the compositional intelligence computing device, may push notifications or schedules/assignments to user devices.

The compositional intelligence computing device is further configured to monitor progress throughout the ongoing project and to feed project progress data back into the compositional model as feedback for validation or adjustment of the modeling functionality. For example, the project progress data indicates that one story took a week longer to complete than the estimate. The compositional model automatically identifies where the (actual) progress project data varies from its estimates or aligns with the estimates, and self-trains using this validation/feedback. Therefore, the model is continuously refined based on ongoing (and sometimes real-time) project progress data.

Moreover, in certain embodiments, the compositional model applies the validation/feedback to the same project, on a continuous or periodic basis. The compositional model may therefore generate revised estimates on a continuous or periodic basis. The compositional intelligence computing device may be configured to identify when a threshold deviation in the estimate is encountered, such as a change in an expected duration beyond a previously output range of estimate duration. The compositional intelligence computing device may generate and transmit a notification to the source system and/or one or more user computing devices. The notification may identify the deviation and, in some instances, a detected source of the deviation (e.g., task 12 is behind estimate by one week). In some cases, the notification may also include instructions for the source system to modify scheduling for the effected workforce.

It should be understood that different enterprise implementations of the computer system of the present disclosure may be associated with unique relevant inputs and outputs.

In one particular example, the computer system may be implemented with respect to an insurance provider. In such an example, projects may be related to the insurance industry, such as the provision of insurance policies. The insurance industry is subject many rules and regulations regarding the provision of insurance policies and related actions. These regulations are frequently location-specific, and national regulations may apply as well as state- or province-level regulations that vary in content and quantity across different states.

In this context, the historical project data may include parameters related to these regulations and the locations (e.g., states) in which they apply. In some embodiments, the enterprise database may further store regulatory information including the content of regulations as well as relevant jurisdictional bodies and/or approval timelines.

Therefore, during the training phase using foundation fine-tuning strategies, the compositional model may be trained to learn and recognize parameters related to regulations and to account for these parameters in discretizing the project (e.g., to include a “regulatory approval” task or story), assigning project elements, estimating timelines, ordering project elements, etc. For example, the compositional model may, when trained, recognize which jurisdictions are more complex or time-consuming, with respect to the regulatory restrictions and framework. The compositional model may account for these locational differences by assigning and estimating completion timelines in less-restrictive jurisdictions first, in some instances, to prioritize project or project element completion in those jurisdictions. In other instances, the compositional model may account for these locational differences by assigning and estimating completion timelines in more-restrictive jurisdictions first, which may facilitate more rapid completion in less-restrictive jurisdictions later.

Additionally or alternatively, these restrictions may be provided to the compositional model during a retrieval augmented generation or manual feedback phase. In such cases, a user may identify, to the compositional model, where regulatory project elements should be accounted for within a timeline or sizing estimate, or may reduce or enlarge certain estimates based on the personal knowledge of how these regulatory restrictions may impact project progress.

### Exemplary Computer System and Devices

FIG. 1 illustrates an exemplary computer system 100. In the exemplary embodiment, the computer system 100 is used for compositional modeling, including executing a large language model (LLM) with foundational fine-tuning and retrieval augmented generation (RAG) techniques to generate deliverables including work sizing estimates, schedules, and other outputs for implementing an enterprise-wide project. The computer system 100 includes the compositional intelligence computing device 150, the enterprise database 110, the source system 120, and one or more user devices 130.

In the exemplary embodiment, the source system 120 and/or user devices 130 are computers that include a web browser or a software application, which enables these devices to communicate with the compositional intelligence computing device 150 using the Internet, a local area network (LAN), or a wide area network (WAN). In some embodiments, user devices 130 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User devices 130 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

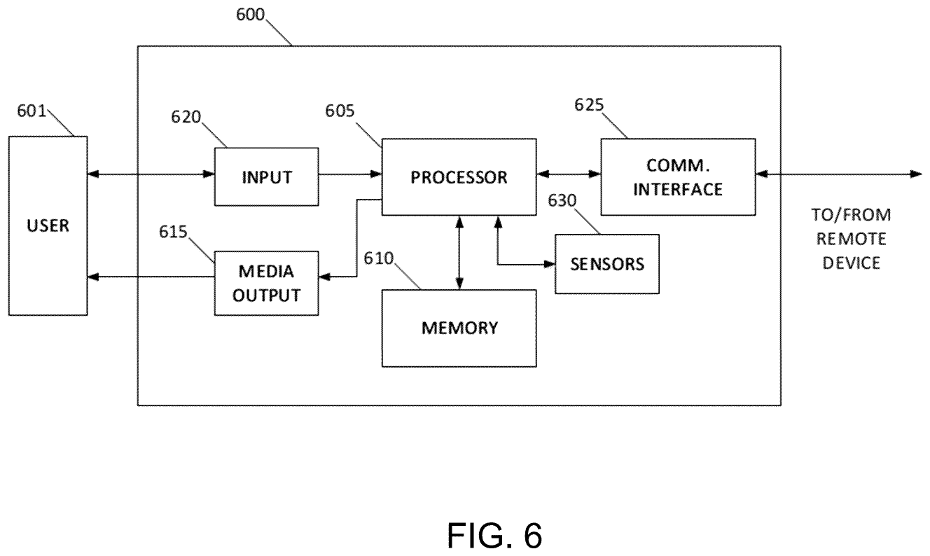

More specifically, FIG. 6 depicts an exemplary configuration of a client computer device shown in FIG. 1, in accordance with one embodiment of the present disclosure. The client computer device 600 may be operated by a user 601. The client computer device 600 may include, but is not limited to, the source system 120 and/or the user devices 130. The client computer device 600 may include a processor 605 for executing instructions. In some embodiments, executable instructions are stored in a memory area 610. Processor 605 may include one or more processing units (e.g., in a multi-core configuration). Memory area 610 may be any device allowing information such as executable instructions and/or transaction data to be stored and retrieved. Memory area 610 may include one or more computer readable media.

The client computer device 600 may also include at least one media output component 615 for presenting information to user 601. Media output component 615 may be any component capable of conveying information to user 601. In some embodiments, media output component 615 may include an output adapter (not shown) such as a video adapter and/or an audio adapter. An output adapter may be operatively coupled to processor 605 and operatively couplable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (eXtended Reality) headsets), and/or voice or chat bots.

In some embodiments, media output component 615 may be configured to present a graphical user interface (e.g., a web browser and/or a client application) to user 601. A graphical user interface may include, for example, an interface for viewing output from the compositional intelligence computing device 150, such as sizing estimates. In some embodiments, the client computer device 600 may include an input device 620 for receiving input from user 601. User 601 may use input device 620 to, without limitation, submits queries, receive model output, and provide feedback.

Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

The client computer device 600 may also include a communication interface 625, communicatively coupled to a remote device such as the compositional intelligence computing device 150. Communication interface 625 may include, for example, a wired or wireless network adapter and/or a wireless data transceiver for use with a mobile telecommunications network.

Stored in memory area 610 are, for example, computer readable instructions for providing a user interface to user 601 via media output component 615 and, optionally, receiving and processing input from input device 620. For example, instructions may be stored by a cloud service, and the output of the execution of the instructions sent to the media output component 615.

Processor 605 executes computer-executable instructions for implementing aspects of the disclosure. In some embodiments, the processor 605 is transformed into a special purpose microprocessor by executing computer-executable instructions or by otherwise being programmed.

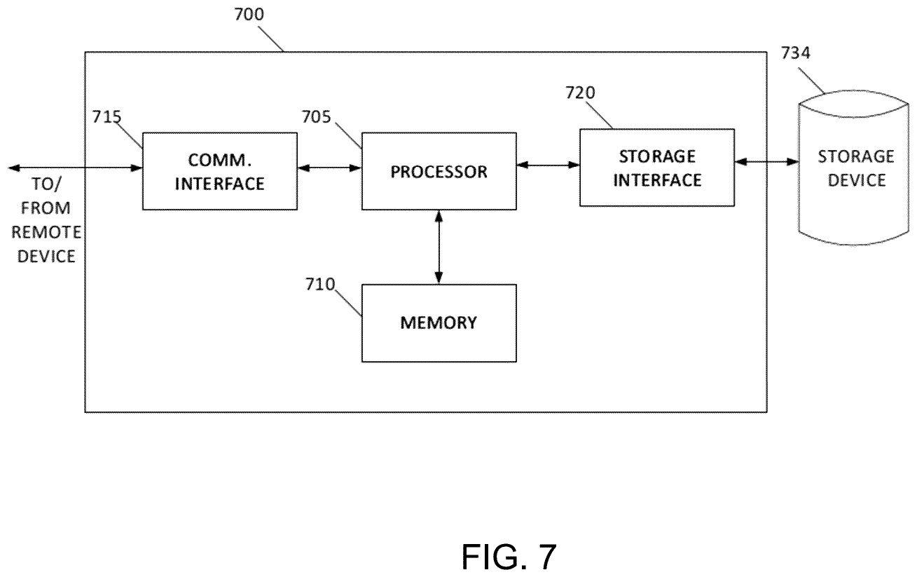

FIG. 7 depicts an exemplary configuration of a server computing device 700, such as the compositional intelligence computing device 150 or the source system 120 shown in FIG. 1, in accordance with one embodiment of the present disclosure. Server computer device 700 may include a processor 705 for executing instructions. Instructions may be stored in a memory area 710. Processor 705 may include one or more processing units (e.g., in a multi-core configuration).

Processor 705 may be operatively coupled to a communication interface 715 such that server computer device 700 is capable of communicating with a remote device such as another server computer device 700 or a client computing device 600 (e.g., via the Internet).

Processor 705 may also be operatively coupled to a storage device 734. Storage device 734 may be any computer-operated hardware suitable for storing and/or retrieving data, such as, but not limited to, data associated with enterprise database 110 (shown in FIG. 1). In some embodiments, storage device 734 may be integrated in server computer device 700. For example, server computer device 700 may include one or more hard disk drives as storage device 734.

In other embodiments, storage device 734 may be external to server computer device 700 and may be accessed by a plurality of server computer devices 700. For example, storage device 734 may include a storage area network (SAN), a network attached storage (NAS) system, and/or multiple storage units such as hard disks and/or solid-state disks in a redundant array of inexpensive disks (RAID) configuration.

In some embodiments, processor 705 may be operatively coupled to storage device 734 via a storage interface 720. Storage interface 720 may be any component capable of providing processor 705 with access to storage device 734. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 734.

Processor 705 may execute computer-executable instructions for implementing aspects of the disclosure. In some embodiments, the processor 705 may be transformed into a special purpose microprocessor by executing computer-executable instructions or by otherwise being programmed.

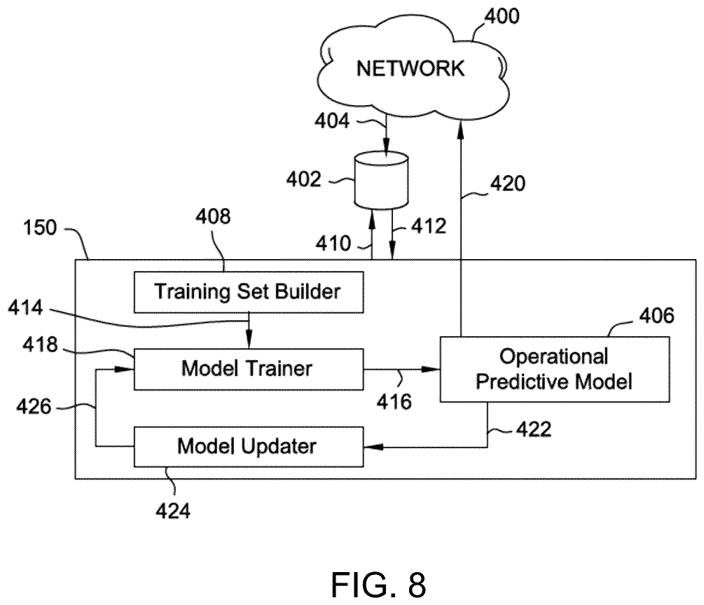

FIG. 8 is a schematic diagram illustrating further detail of the compositional intelligence computing device 150 (shown in FIG. 1). The compositional intelligence computing device 150 may communicate with other components of the computer system 100, such as the source system 120 or user devices 130 (both shown in FIG. 1). The compositional intelligence computing device 150 may include and/or be in communication with a database 402, such as the enterprise database 110 (also shown in FIG. 1) that stores data 404 including historical project data, workplace data, and other information relevant to generating project sizing estimates. Data 404 received from sources via network 400 may be stored in database 402. The compositional intelligence computing device 150 may configured to use data 404 to generate an operational predictive model module 406 for generating project sizing estimates.

In exemplary embodiments, the compositional intelligence computing device 150 includes a training set builder module 408 configured to submit one or more queries 410 to database 402 to retrieve subsets 412 of data 404, and to use those subsets 412 to build training data sets 414 for generating operational predictive model 406. For example, query 410 may be configured to retrieve certain fields from data 404 for historical project having similarities to a project related to a query.

In exemplary embodiments, training set builder module 408 may be configured to derive training data sets 414 from retrieved subsets 412. Each training data set 414 corresponds to historical data 404 (“historical” in this context means completed in the past, as opposed to completed in real-time with respect to the time of retrieval by training set builder module 408). Each training data set 414 may include “model input” data fields along with at least one “result” data field representing historical feedback, such as project or project element outcomes. The model input data fields represent factors that may be expected to, or unexpectedly be found during model training to, have some correlation with project estimations.

In exemplary embodiments, the model input data fields in training data sets 414 may be generated from data fields in subset 412 corresponding to historical data 404. In other words, a trained machine learning model 416 (e.g., the compositional model) produced by a model trainer module 418 for use by operational predictive model module 406 is trained to make predictions based upon input values that can be generated from the data fields in data 404. Values in the model input data fields may include values copied directly from values in a corresponding data field in the retrieved subset 412, and/or values generated by modifying, combining, or otherwise operating upon values in one or more data fields in the retrieved subset 412.

After training set builder module 408 generates training data sets 414, training set builder module 408 passes the training data sets 414 to model trainer module 418. In example embodiments, model trainer module 418 is configured to apply the model input data fields of each training data set 414 as inputs to one or more machine learning models (e.g., the compositional model). Each of the one or more machine learning models is programmed to produce, for each training data set 414, at least one output intended to correspond to, or “predict,” a value of the at least one result data field of the training data set 414. “Machine learning” refers broadly to various algorithms that may be used to train the model to identify and recognize patterns in existing data in order to facilitate making predictions for subsequent new input data.

Model trainer module 418 is configured to compare, for each training data set 414, the at least one output of the model to the at least one result data field of the training data set 414, and apply a machine learning algorithm to adjust parameters of the model in order to reduce the difference or “error” between the at least one output and the corresponding at least one result data field. In this way, model trainer module 418 trains the machine learning model to accurately predict the value of the at least one result data field. In other words, model trainer module 418 cycles the one or more machine learning models through the training data sets 414, causing adjustments in the model parameters, until the error between the at least one output and the at least one result data field falls below a suitable threshold, and then uploads at least one trained machine learning model 416 to operational predictive model module 406 for application to generating predictions 420. In exemplary embodiments, model trainer module 418 may be configured to simultaneously train multiple candidate machine learning models and to select the best performing candidate for each result data field, as measured by the “error” between the at least one output and the corresponding result data field, to upload to operational predictive model module 406.

In certain embodiments, the one or more machine learning models (e.g., the compositional model) may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer. As model trainer module 418 cycles through the training data sets 414, model trainer module 418 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 418 provides an advantage by automatically discovering and properly weighting complex, second- or third-order, and/or otherwise nonlinear interconnections between the model input data fields and the at least one output. Absent the machine learning model, such connections are unexpected and/or undiscoverable by human analysts.

In exemplary embodiments, operational predictive model module 406 may compare feedback (e.g., project progress data from actual ongoing projects), and may route a comparison result 422 generated by comparing prediction 420 to the feedback to a model updater module 424 of the compositional intelligence computing device 150. Model updater module 424 is configured to derive a correction signal 426 from comparison results 422 received for one or more predictions 420, and to provide correction signal 426 to model trainer module 418 to enable updating or “re-training” of the at least one machine learning model to improve performance. The retrained at least one machine learning model 416 may be periodically re-uploaded to operational predictive model module 406.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, the compositional intelligence computing device 150 is configured to implement machine learning, such that the compositional intelligence computing device 150 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to text, queries, images, binary feedback, selectable feedback, etc. ML outputs may include, but are not limited to identifications, classifications, relationships, trends, patterns, and/or other data extracted from the inputs. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of historical project data and workplace data with known characteristics or features.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments, and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

### Example Computer Systems, Methods, and Storage Media

Described herein are computer systems such as the computer devices and related computer systems forming the work estimation computer system. In some exemplary embodiments, disclosed herein is a computer system including: one or more data sources storing historical action outcome data, historical resource data, and current resource data associated with an enterprise, and a compositional intelligence computing device including at least one processor and at least one memory device. The at least one processor is configured to: (a) train a compositional model using the historical action outcome data and the historical resource data; (b) receive, from a user device, a query identifying a deliverable; (c) input a prompt associated with the query to the compositional model; (d) execute the compositional model using the prompt and the current resource data to generate output including the deliverable; (e) provide the deliverable to the user device; (f) receive, from the user device, feedback related to the deliverable; (g) re-execute the compositional model using the feedback to generate output including a revised deliverable; and (h) control a resource scheduling component to implement one or more actions related to the deliverable.

In some instances, to train the compositional model, the at least one processor is further configured to execute foundational fine-tuning using the historical action outcome data and the historical resource data.

In some embodiments, the at least one processor is further configured to re-train the compositional model using the feedback.

In some further instances, the deliverable is associated with an enterprise project, and the at least one processor is further configured to: continuously or periodically monitor progress data related to the enterprise project; and continuously or periodically re-execute the compositional model using the progress data.

In some embodiments, the deliverable is associated with an enterprise project, and the compositional model is configured to, when executed, discretize the enterprise project into a plurality of hierarchical project elements. In some such embodiments, the deliverable includes a project sizing estimate that includes an identification of at least a subset of the project elements.

In some cases, the deliverable includes a project sizing estimate that includes an estimated duration of a related enterprise project and a proposed team including workforce resources. In some such cases, the project sizing estimate further includes at least one of: a confidence level associated with the estimated duration, or one or more assumptions or inferences used by the compositional model to generate the deliverable.

In some further embodiments, the output from the re-executed compositional model further includes an identification of one or more changes between the deliverable and the revised deliverable.

In some additional or alternative embodiments, the at least one processor is further configured to generate the prompt by modifying the query to include one or more additional parameters.

In some exemplary embodiments, a computer-implemented method for compositional modeling and generating deliverables is disclosed. The method may be implemented using a computer system including at least one processor and at least one memory device. The method may include: (a) accessing one or more data sources to retrieve historical action outcome data, historical resource data, and current resource data associated with an enterprise; (b) training a compositional model using the historical action outcome data and the historical resource data; (c) receiving, from a user device, a query identifying a deliverable; (d) inputting a prompt associated with the query to the compositional model; (e) executing the compositional model using the prompt and the current resource data to generate output including the deliverable; (f) providing the deliverable to the user device; (g) receiving, from the user device, feedback related to the deliverable; (h) re-executing the compositional model using the feedback to generate output including a revised deliverable; and/or (i) controlling a resource scheduling component to implement one or more actions related to the deliverable.

In some cases, training the compositional model includes executing foundational fine-tuning using the historical action outcome data and the historical resource data.

In some embodiments, the method also includes re-training the compositional model using the feedback.

In some instances, the deliverable is associated with an enterprise project, and the method further comprises: continuously or periodically monitoring progress data related to the enterprise project; and continuously or periodically re-executing the compositional model using the progress data.

In some embodiments, the deliverable is associated with an enterprise project, and executing the compositional model includes discretizing, by the compositional model, the enterprise project into a plurality of hierarchical project elements.

In some cases, the method further includes generating the prompt by modifying the query to include one or more additional parameters.

In some exemplary embodiments, one or more non-transitory computer-readable storage media having stored thereon computer-executable instructions are disclosed. When executed by at least one processor, the computer-executable instructions cause the at least one processor to: (a) access one or more data sources to retrieve historical action outcome data, historical resource data, and current resource data associated with an enterprise; (b) train a compositional model using the historical action outcome data and the historical resource data; (c) receive, from a user device, a query identifying a deliverable; (d) input a prompt associated with the query to the compositional model; (e) execute the compositional model using the prompt and the current resource data to generate output including the deliverable; (f) provide the deliverable to the user device; (g) receive, from the user device, feedback related to the deliverable; (h) re-execute the compositional model using the feedback to generate output including a revised deliverable; and/or (i) control a resource scheduling component to implement one or more actions related to the deliverable.

In some cases, the computer-executable instructions further cause the at least one processor to train the compositional by executing foundational fine-tuning using the historical action outcome data and the historical resource data.

In some embodiments, the deliverable is associated with an enterprise project, and the computer-executable instructions further cause the at least one processor to: continuously or periodically monitor progress data related to the enterprise project; and continuously or periodically re-execute the compositional model using the progress data.

In some instances, the deliverable is associated with an enterprise project, and the compositional model is configured to, when executed, discretize the enterprise project into a plurality of hierarchical project elements.

### Additional Considerations

Described herein are computer systems such as the computer devices and related computer systems forming the work estimation computer system. As described herein, all such computer systems include a processor and a memory. However, any processor in a computer device referred to herein can also refer to one or more processors wherein the processor can be in one computing device or a plurality of computing devices acting in parallel. Additionally, any memory in a computer device referred to herein can also refer to one or more memories wherein the memories can be in one computing device or a plurality of computing devices acting in parallel.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein may include or be implemented via computer-executable instructions stored on non-transitory computer-readable media or medium.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments can enhance the functionality and functioning of computers and/or computer systems.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

Disjunctive language such as the phrase “at least one of X, Y, or Z,” unless specifically stated otherwise, is generally understood within the context as used to state that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system comprising:
one or more data sources storing historical action outcome data, historical resource data, and current resource data associated with an enterprise; and
a compositional intelligence computing device comprising at least one processor and at least one memory device, the at least one processor configured to:
train a compositional model using the historical action outcome data and the historical resource data;
receive, from a user device, a query identifying a deliverable;
input a prompt associated with the query to the compositional model;
execute the compositional model using the prompt and the current resource data to generate output including the deliverable;
provide the deliverable to the user device;
receive, from the user device, feedback related to the deliverable;
re-execute the compositional model using the feedback to generate output including a revised deliverable; and
control a resource scheduling component to implement one or more actions related to the deliverable.

2. The computer system of claim 1, wherein to train the compositional model, the at least one processor is further configured to execute foundational fine-tuning using the historical action outcome data and the historical resource data.

3. The computer system of claim 1, wherein the at least one processor is further configured to re-train the compositional model using the feedback.

4. The computer system of claim 1, wherein the deliverable is associated with an enterprise project, and wherein the at least one processor is further configured to:
continuously or periodically monitor progress data related to the enterprise project; and
continuously or periodically re-execute the compositional model using the progress data.

5. The computer system of claim 1, wherein the deliverable is associated with an enterprise project, wherein the compositional model is configured to, when executed, discretize the enterprise project into a plurality of hierarchical project elements.

6. The computer system of claim 5, wherein the deliverable includes a project sizing estimate that includes an identification of at least a subset of the project elements.

7. The computer system of claim 1, wherein the deliverable includes a project sizing estimate that includes an estimated duration of a related enterprise project and a proposed team including workforce resources.

8. The computer system of claim 7, wherein the project sizing estimate further includes at least one of: a confidence level associated with the estimated duration, or one or more assumptions or inferences used by the compositional model to generate the deliverable.

9. The computer system of claim 1, wherein the output from the re-executed compositional model further includes an identification of one or more changes between the deliverable and the revised deliverable.

10. The computer system of claim 1, wherein the at least one processor is further configured to generate the prompt by modifying the query to include one or more additional parameters.

11. A computer-implemented method for compositional modeling and generating deliverables, the method implemented using a computer system including at least one processor and at least one memory device, the method comprising:
accessing one or more data sources to retrieve historical action outcome data, historical resource data, and current resource data associated with an enterprise;
training a compositional model using the historical action outcome data and the historical resource data;
receiving, from a user device, a query identifying a deliverable;
inputting a prompt associated with the query to the compositional model;
executing the compositional model using the prompt and the current resource data to generate output including the deliverable;
providing the deliverable to the user device;
receiving, from the user device, feedback related to the deliverable;
re-executing the compositional model using the feedback to generate output including a revised deliverable; and
controlling a resource scheduling component to implement one or more actions related to the deliverable.

12. The computer-implemented method of claim 11, wherein training the compositional model comprises executing foundational fine-tuning using the historical action outcome data and the historical resource data.

13. The computer-implemented method of claim 11, further comprising re-training the compositional model using the feedback.

14. The computer-implemented method of claim 11, wherein the deliverable is associated with an enterprise project, and wherein the method further comprises:
continuously or periodically monitoring progress data related to the enterprise project; and
continuously or periodically re-executing the compositional model using the progress data.

15. The computer-implemented method of claim 11, wherein the deliverable is associated with an enterprise project, and wherein executing the compositional model comprises discretizing, by the compositional model, the enterprise project into a plurality of hierarchical project elements.

16. The computer-implemented method of claim 11, further comprising generating the prompt by modifying the query to include one or more additional parameters.

17. One or more non-transitory computer-readable storage media having stored thereon computer-executable instructions that, when executed by at least one processor, cause the at least one processor to:
access one or more data sources to retrieve historical action outcome data, historical resource data, and current resource data associated with an enterprise;
train a compositional model using the historical action outcome data and the historical resource data;
receive, from a user device, a query identifying a deliverable;
input a prompt associated with the query to the compositional model;
execute the compositional model using the prompt and the current resource data to generate output including the deliverable;
provide the deliverable to the user device;
receive, from the user device, feedback related to the deliverable;
re-execute the compositional model using the feedback to generate output including a revised deliverable; and
control a resource scheduling component to implement one or more actions related to the deliverable.

18. The one or more non-transitory computer-readable storage media of claim 17, wherein the computer-executable instructions further cause the at least one processor to train the compositional by executing foundational fine-tuning using the historical action outcome data and the historical resource data.

19. The one or more non-transitory computer-readable storage media of claim 17, wherein the deliverable is associated with an enterprise project, and wherein the computer-executable instructions further cause the at least one processor to:
continuously or periodically monitor progress data related to the enterprise project; and
continuously or periodically re-execute the compositional model using the progress data.

20. The one or more non-transitory computer-readable storage media of claim 17, wherein the deliverable is associated with an enterprise project, wherein the compositional model is configured to, when executed, discretize the enterprise project into a plurality of hierarchical project elements.
